(19) United States
(12) Patent Application Publication
(10) Pub. No.: US 2017/0195744 A1
(43) Pub. Date: Jul. 6, 2017

(54) Live-stream video advertisement system

(71) Applicants: Thomas William Engel, Haarlem (NL); Erik Wallentinsen, Amsterdam (NL); Roy Meister, Castricum (NL); Schalk Stalman, Alkmaar (NL)

(72) Inventors: Thomas William Engel, Haarlem (NL); Erik Wallentinsen, Amsterdam (NL); Roy Meister, Castricum (NL); Schalk Stalman, Alkmaar (NL)

(21) Appl. No.: 14/984,748

(22) Filed: Dec. 30, 2015

(30) Foreign Application Priority Data
Dec. 30, 2015 (NL) 2016051

(51) Int. Cl. H04N 21/81; H04N 21/482; H04N 21/858; H04N 21/234; H04L 29/06; H04L 29/08

(52) U.S. Cl. CPC H04N 21/812; H04L 65/60; H04L 65/4069; H04L 67/02; H04N 21/8586; H04N 21/23424; H04N 21/4825

(57) ABSTRACT

A method of forming a live-stream advertisement video clip is described wherein the method comprises: receiving live-stream video segments associated with a live-streaming session, wherein each of the live-stream segments is identified by a live-stream segment identifier, preferably an URL or an URI; updating a dynamic playlist, preferably a live-stream playlist, on the basis of the live-stream segments identifiers of the received live-stream segments; forming a static playlist, preferably a video-on-demand playlist, on the basis of live-stream identifiers in said updated dynamic playlist, the static playlist comprising the most recently available live-stream segment identifiers of the updated dynamic playlist and/or live-stream segment identifiers that are going to be available in the future; and, associating video and/or audio advertisement information with the live-stream segment identifiers.

### BACKGROUND

The discussion below is merely provided for general background information and is not intended to be used as an aid in determining the scope of the claimed subject matter.

Generally aspects of the invention relate to live-stream video advertising, and, in particular, though not exclusively, to methods and systems for live-stream video advertisement, a client device configured for live-stream video advertisement and a server for live-stream video advertisement, and a computer program product for executing such methods.

Currently video advertising is an important means for generating revenue from video content publishing. Typically, before playing a selected video a short advertisement video clip is played out. Such video advertisement is commonly referred to as a pre-roll, mid-roll or post-roll advertisement clip. These video clips are typically non-interactive video clips that are processed as a conventional video-on-demand video from an advertisement server.

The Digital Video Advertising Serving Template (VAST) standard, as e.g. described in the draft VAST 4.0 standard as published on 2 Nov. 2015 by the IAB, provides a standardized format for video advertisement. When starting an online video, a VAST-compatible video player may send a VAST request to an ad server which returns a VAST response comprising a standardized XML type file that can be parsed by the video player. The video player may use a video ad identifier, e.g. an URL, in the response for requesting an advertisement video clip and other advertisement content, e.g. banners or the like, from an ad server.

The VAST standard provides a simple way for content providers for adding video ads to online video content. In the VAST standard video ads are retrieved on the basis of conventional video-on-demand techniques and does not allow rendering of live-streaming video in pre-, mid-, of post-roll type video advertisement. Currently, however, more and more live-stream content is offered. The production costs of live-sports events and/or the acquisition costs of live-streaming broadcast rights (e.g. big sports or music events) are very high. Once such broadcast rights are acquired they could be bundled with other broadcast rights and sold as a pay-TV subscription to customers. Since the amount of content that is offered to the public is continuously growing and the technology to access the content (e.g. in the form of an over-the-top (OTT) service, mobile video apps or broadcast television) is rapidly developing, it is of utmost importance to bring the live-content to the attention of the relevant part of the public at the right moment, typically when the live-stream is going to be broadcasted. As the live-stream techniques are not compatible with the VAST standard, there is no simple and easy accessible solution for live-stream video advertising.

Hence, there is a need in the art for improved methods and systems that enable simple and cheap generation and playback of live-stream video advertisements. In particular, there is a need in the art for methods and system that enable live-stream video advertisements that are compatible with video ad standards such as VAST.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “component” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks. Many of the modules, components and the like can also be implemented using software executed on processing circuitry having a suitable processor with memory to store the executable instructions and/or data. The circuitry can further include without limitation logic arrays and a system on a chip implementation that integrates some if not all circuitry and components of a computer or other electronic system that processes digital signals, analog signals, and/or mixed digital and analog signals on a single chip substrate.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is desirable to enable the formation and playout of an advertisement video clip that comprises live-content of a live-streaming session that is ongoing when the advertisement video clip is requested. In particular, the embodiments in this disclosure enable the formation and playout of in-stream (pre-, mid-, or post-roll) or out-stream (for example standalone on a website) advertisement video clips comprising segments of a live feed (e.g. sports or music content), including a visual and/or audio overlay for promoting the live-content and for informing a viewer that the live-content is part of an advertisement video clip. Further, it is an objective of the invention to reduce or eliminate at least one of the drawbacks known in the prior art.

In an aspect the invention may relate to a method for forming a live-stream advertisement video clip.

In an embodiment, the method may comprise: updating a dynamic playlist, preferably a live-stream playlist, on the basis of live-stream segments identifiers identifying live-stream segments of a live-streaming session; forming a static playlist, preferably a video-on-demand playlist, on the basis of live-stream identifiers in said updated dynamic playlist, the static playlist comprising the most recently available live-stream segment identifiers of the updated dynamic playlist; and, associating video and/or audio advertisement information with the live-stream segment identifiers.

In an embodiment, the method may comprise: a network node receiving live-stream video segments associated with a live-streaming session, wherein each of the live-stream segments is identified by a live-stream segment identifier, preferably a URL; updating a live-stream playlist stored on the network node on the basis of the live-stream segments identifiers of the received live-stream segments; forming a static video-on-demand playlist on the basis of live-stream identifiers in said updated live-stream playlist, the static video-on-demand playlist comprising the most recently available live-stream segment identifiers of the updated live-stream playlist and/or live-stream segment identifiers that are going to be available in the future; and, associating video and/or audio advertisement information with the live-stream segment identifiers.

In another embodiment, the method may comprise: a network node continuously or periodically receiving live-stream segments, each of the segments being associated with a live-stream segment identifier, preferably an URL; continuously or periodically updating a live-stream playlist on the basis of the received live-stream segments, the live-stream playlist file identifying the n most recent live-stream segments received by said network node; forming a video-on-demand playlist on the basis of the live-stream playlist file, the video-on-demand playlist comprising one or more live-stream segment identifiers published in the live-stream playlist and/or live-stream segment identifiers that are going to be published in the live-stream playlist; and, associating the media data of the live-stream segments identified in the video-on-demand playlist with (video and/or audio) advertisement information.

In these embodiments, methods are presented wherein a dynamic (live-stream) playlist associated with the live-streaming session is used in order to (continuously or periodically) form new static playlists comprising live-stream advertisement segment identifiers of the most recently formed live-stream segments or of live-stream segments that are going to be in the (near) future (e.g. within a predetermined time from the moment the static playlist comprising live-stream segment identifiers is formed). The associated live-stream segments identified in such static playlist may be associated (linked) with advertisement information, e.g. a video overlay and/or an audio overlay, in order to inform a viewer during playout of the live-stream segment identified in the playlist that the clip is in fact a live-stream video advertisement clip.

By transforming parts of a dynamic (live-stream) playlist into a static video-on-demand (VOD) playlist, live-stream segments may be used in live-stream video ad services which can be rendered using conventional client devices that support VAST compliant video ads. In particular, the embodiments allow standard VAST compliant video players to render video ads comprising content of live-stream that is played-out at that moment. This way, a content provider or a broadcaster may use the live-stream video ad to inform viewers of a live-stream (e.g. of a sports or music event) that is broadcasted (or going to be broadcasted).

In an embodiment, the live-stream segment identifiers may comprise a counter and/or time information for signaling the client device the order in which the live-stream segments should be played-out.

In an embodiment, the static playlist may comprise an availability indicator for signaling a client device that the live-stream segments are going to be available at some time in the (near) future. Hence, in that case the client may wait for the availability of the live-stream segments before it starts requesting them.

In an embodiment, the client device may use the information in the static playlist, in particular the segment time stamp and/or counter associated with the live-stream identifiers, in order to determine at what time it should start requesting the live-stream segments identified in the static playlist.

In an embodiment, the static playlist may comprise availability information, e.g. a clock time or the like, for signaling a client device at what time it should start requesting and playout live-stream segments that are listed in the static playlist it received.

In an embodiment, associating visual and/or audio advertisement information with the live-stream segment identifiers may comprise: adding an advertisement information identifier associated with the video and/or audio advertisement information in the static video-on-demand playlist. Hence, in this embodiment, the client device may use information in the playlist in order to retrieve the advertisement information.

In an embodiment, associating visual and/or audio advertisement information with the live-stream segment identifiers may comprise: adding video and/or audio advertisement information, preferably a video overlay or an audio overlay, to the received live-stream video segments. In this embodiment, advertisement information is added to the live-segments (using e.g. a transcoding process) so that the media data can be played-out without any additional processing on the client-side.

In a further embodiment, the method may comprise storing the static playlist, the live-stream segments identified in the playlist and the video and/or audio advertisement information on a server system. Hence, once a new static playlist is formed the playlist and the segments are stored on one or more servers so that they can be retrieved by client devices. A newly formed playlist may overwrite the older playlist so that only the most recent playlist identifying the most recent live-stream segments is made available to the client devices.

In an embodiment, the live-stream segments, the live-stream playlist and the video-on-demand playlist are formatted according to an HTTP streaming protocol.

In a further aspect, the invention may relate to a method of rendering a live-stream advertisement video clip. In an embodiment, the method may comprise: a client device receiving a static video-on-demand playlist comprising one or more live-stream segment identifiers, the static video-on-demand playlist comprising the most recently available live-stream segment identifiers published in a dynamical live-stream playlist and/or live-stream segment identifiers that are going to be available in the future; requesting live-stream segments on the basis of the live-stream segments identifiers in the static video-on-demand playlist and requesting video and/or audio advertisement information, preferably a video or audio overlay, associated with the live-stream segment identifiers; and, the client device controlling a media player and an advertisement information processor to simultaneously playout media data of the received live-stream segments and the advertisement information as a live-stream video advertisement clip on a display of a media processing device.

In this embodiment, the client device requests and processes the advertisement information separately from the media data in the live-stream segments. Hence, this embodiment does not require that the advertisement information is added to the segments in the network. This embodiment may thus save encoding resources, as the original live-stream does not require continuous, real-time transcoding in the network.

Furthermore, this embodiment enables the client device to control the enhancement of the media data of the live-streaming segments with advertisement information. For example, it enables the client device to determine the time of the start of the overlay video. In another embodiment, it allows the execution of an interactive overlay, e.g. an HTML5 or CSS overlay comprising an interaction area, e.g. button, that may be used to redirect the user to a website where the advertised live-stream can be accessed.

In a further embodiment, the method may further comprise: requesting a server, preferably a VAST compliant advertisement server, information for rendering a live-stream advertisement video clip; receiving a response, preferably a VAST response, from the server, the response comprising one or more references, preferably one or more URLs, for locating one or more servers configured to provide the static video-on-demand playlist and/or the advertisement information to the client device.

In an embodiment, the response may further comprise information for signaling the client device that visual advertisement information can be retrieved on the basis of the one or more references and/or for initializing the advertisement information processor for playout of advertisement information identified in the response. Hence, in this embodiment, the response of the ad server, which may be a VAST compliant ad server, may provide the client device with information on the advertisement information that needs to be played-out by the advertisement information processor.

In a further embodiment, the advertisement information processor may use the advertisement information for rendering an interactive region on a user interface, preferably an interactive region on a touch-sensitive display, during the playout of the media data in the live-stream segments, preferably when interacting with the interactive region, the client device being redirected the client to a server for joining the live-stream session.

In a further aspect, the invention may relate to a server comprising: a computer readable storage medium having computer readable program code embodied therewith, and a processor, preferably a microprocessor, coupled to the computer readable storage medium, wherein responsive to executing the first computer readable program code, the processor is configured to perform executable operations comprising: receiving live-stream video segments associated with a live-streaming session, wherein each of the live-stream segments is identified by a live-stream segment identifier, preferably a URL; updating a live-stream playlist stored on the network node on the basis of the live-stream segments identifiers of the received live-stream segments; forming a static video-on-demand playlist on the basis of live-stream identifiers in said updated live-stream playlist, the static video-on-demand playlist comprising the most recently available live-stream segment identifiers of the updated live-stream playlist and/or live-stream segment identifiers that are going to be available in the future; and, associating video and/or audio advertisement information with the live-stream segment identifiers.

In an embodiment, the executable operations may further comprise: adding an advertisement information identifier associated with the video and/or audio advertisement information in the static video-on-demand playlist; or, adding video and/or audio advertisement information to the received live-stream video segments; or, storing the static video-on-demand playlist, the live-stream segments identified in the playlist and the video and/or audio advertisement information.

In yet another aspect, the invention may relate to a client device comprising: a computer readable storage medium having at least part of a program embodied therewith, the computer readable storage medium comprising a playlist file; and, a computer readable storage medium having computer readable program code embodied therewith, and a processor, preferably a microprocessor, coupled to the computer readable storage medium, wherein responsive to executing the computer readable program code, the processor is configured to perform executable operations comprising: a client device receiving a static video-on-demand playlist comprising one or more live-stream segment identifiers, the static video-on-demand playlist comprising the most recently available live-stream segment identifiers published in a dynamic live-stream playlist and/or live-stream segment identifiers that are going to be published in the dynamic playlist; requesting live-stream segments on the basis of the live-stream segments identifiers in the static video-on-demand playlist and requesting video and/or audio advertisement information, preferably a video or audio overlay, associated with the live-stream segment identifiers; and, the client device controlling a media player and an advertisement information processor to simultaneously playout media data of the received live-stream segments and the advertisement information as a live-stream video advertisement clip on a display of a media processing device.

In an embodiment, the executable operations further comprise: requesting a server, preferably a VAST compliant advertisement server, information for rendering a live-stream advertisement video clip; receiving a response, preferably a VAST response, from the server, the response comprising one or more references, preferably one or more URLs, for locating one or more servers configured to provide the static video-on-demand playlist and/or the advertisement information to the client device.

In an embodiment, the executable operations may further comprise: initializing the advertisement information processor for playout of advertisement information identified in the response.

In an embodiment, the executable operations may further comprise: rendering an interactive region on a user interface, preferably an interactive region on a touch-sensitive display, during the playout of the media data in the live-stream segments, preferably when interacting with the interactive region, the client device being triggered to join the live-stream session.

The invention may also relate to a program product comprising software code portions configured for, when run in the memory of a computer, executing the method steps according to any of the method claims described above.

Aspects of the invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 schematically depicts a live-streaming video advertisement system according to an embodiment of the invention.

FIG. 2 depicts a schematic of generating a playlist file for playout of a live-stream video advertisement according to an embodiment of the invention.

FIG. 3 depicts a method of rendering a live-stream video advertisement according to an embodiment of the invention.

FIG. 4 schematically depicts a live-streaming video advertisement system according to another embodiment of the invention.

FIG. 5 depicts a method of rendering a live-stream video advertisement according to another embodiment of the invention.

FIG. 6 depicts a block diagram illustrating an exemplary data processing system that may be used in as described in this disclosure.

### DETAILED DESCRIPTION

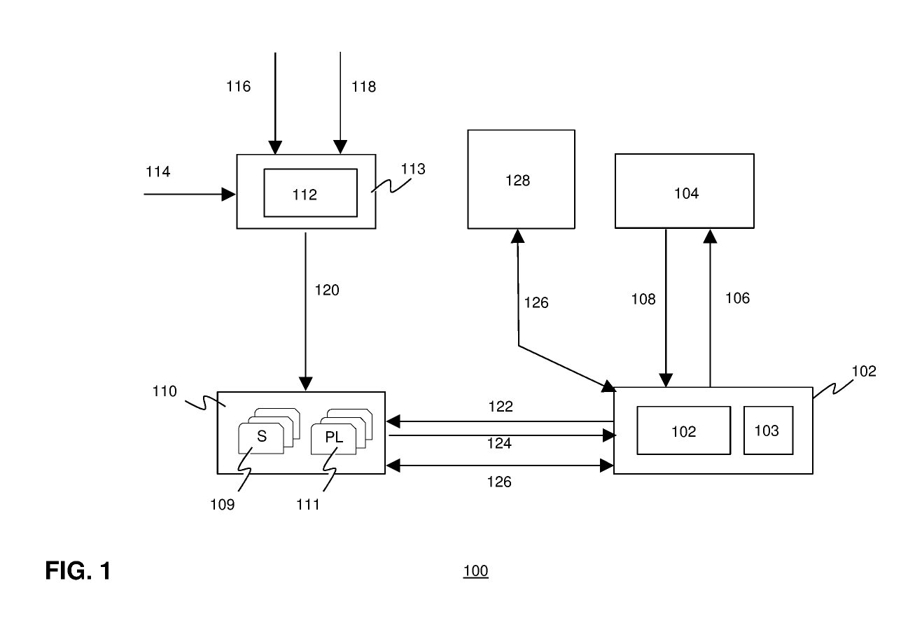

FIG. 1 schematically depicts a video advertising system according to an embodiment of the invention. In particular, FIG. 1 depicts a client device 102 implemented on a media processing device 104. A media processing device may generally relate to a content processing device, e.g. a (mobile) content play-out device such as an electronic tablet, a smart-phone, a notebook, a media player, a television, etc. In some embodiment, a media device may be a set-top box or content storage device configured for processing media.

The client device 102 may be configured for executing an advertisement application that is configured to enable a user to select (e.g. on the basis of user interface, e.g. a touch-sensitive display) a video title for play-out. Based on the selection the client device 102 may then send a request 106 to an advertisement (ad) server for delivery of a video advertisement clip. Once the media data of the clip are received the client device 102 may triggered a media player 103 to playout the video ad clip. The clip may be short 15-30 second video that is played-out before, during or after the video that a viewer is going to watch or is watching. The ad-server may be part of an advertisement (ad) network, e.g. an online advertising network that connects advertisers to web sites that hosts video advertisement services.

The client device 102 may support VAST video clip playout. The Digital Video Advertising Serving Template (VAST) standard is a standard defining a communication protocol between ad servers and a video player (or a client device 102 that controls a video player). In order to play-out a video ad clip, the client device 102 may send a VAST request 106, e.g. an HTTP request, to a VAST-compatible ad server 104. In return the ad server 104 may send an ad server response 108, preferably a VAST response, to the client device 102. The VAST response may comprise a XML file comprising metadata, in particular one or more references, URLs, identify one or more media servers 126 that are configured to deliver one or more video advertisement clips to a client device 102.

In particular, the client device 102 may use an URL in the ad server response 108 in order to request and receive 126 an advertisement video clip from a media server 128. The request may be an HTTP request comprising an URL for retrieving a video clip for play out using a conventional, well-known video-on-demand (VOD) technique. The video clip may be transmitted to the client device 102 using an adaptive video streaming technique such as HTTP live streaming (HLS) or another known HTTP adaptive streaming technique.

For example, in response to the video ad request the video player may receive a playlist file, e.g. an HLS .m3u8 playlist file, comprising metadata for downloading a sequence of small media data files, usually referred to as media segments (sometimes also referred to as fragments). The playlist file, or in short playlist, may comprise segment identifiers, i.e. one or more URLs, that may be used to locate an HTTP server from which the identified segments, i.e. small video files of 2-10 second content, may be downloaded. The segment identifiers in the playlist file may identify segments comprising the content in different video qualities. By requesting segments from an HTTP server on the basis of the information in the playlist file and by sequential play-out of the media data in the requested and downloaded segments, a continuous video ad clip can be rendered. This way, conventional pre-, mid, and post roll video clips may be rendered when a user of the client device 102 is watching or going to watch online video content.

In contrast with conventional video advertising systems, the system in FIG. 1 is also configured to offer client devices the possibility of live-stream video ads. To that end, the system may comprise a network node 113, e.g. a server or a proxy, comprising a video advertisement (ad) processor 112 that is configured to receive live-streaming video content from one or more content sources (not shown). In particular, the video ad processor 112 may be configured to receive and buffer live-stream segments 118. Additionally, it may be configured to form a live-stream playlist 116 which is dynamically updated on the basis of the received live-stream segments. The update process maintains the information in a live-stream playlist 116 in sync with the received segments. Hence, during the reception of the live-streaming segments, the network node 113 may continuously update the playlist file such that it always identifies the most recent segments.

Further, the video ad processor 112 may be configured to process the received live-stream segments and transform the live-stream segments into live-stream advertisement segments. This modification process may include the addition of advertisement information 114 to the video/audio (AV) media data in the live-stream segments. For example, the advertisement information may include a video overlay that is added to the media data in the segment using a conventional transcoding process. Hence, in an embodiment, advertisement information (e.g. a video and/or sound overlay) may be added to the segments of the live-stream in order to make the live-stream segments suitable for advertisement. The added video and/or sound overlay may include information for notifying a viewer that the live-stream video that is played is in fact a (short) live-stream video advertisement. The advertisement information may include graphical overlay like: a “LIVE” indicator, icon or brand logo, custom graphics, additional (textual) metadata.

During the reception and modification of the live-stream segments and the associated update of the live-stream playlist file, the video ad processor 112 may select one or more subsequent live-stream advertisement segments and form a playlist file comprising segment identifiers forming a live-stream video ad. This playlist may be referred to as an advertisement playlist. Here, the advertisement playlist is not a live-stream playlist file, i.e. a playlist file that is continuously (dynamically) updated with new segment identifiers, e.g. URLs. Instead, the advertisement playlist is a static playlist file identifying the live-stream advertisement segments forming a live-stream advertisement video clip.

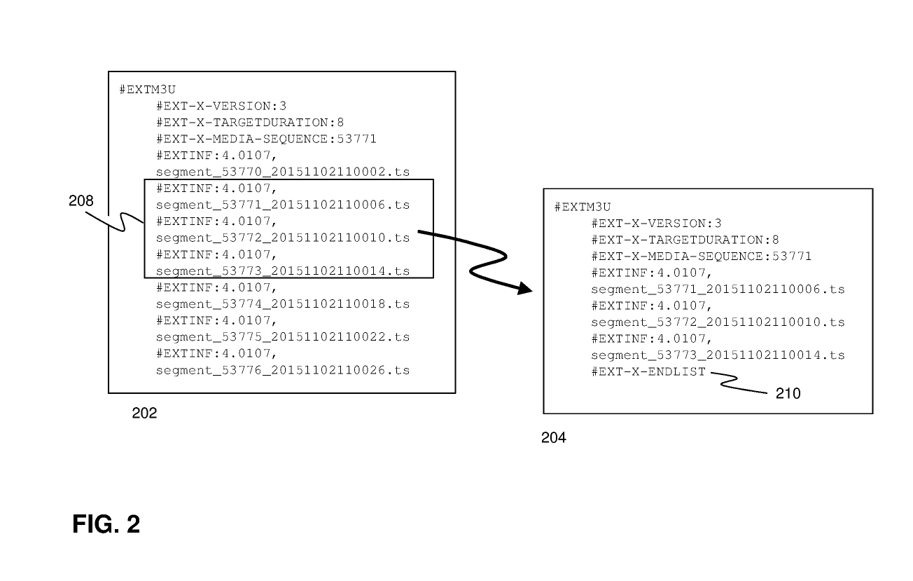

FIG. 2 depicts a schematic of generating a playlist file for playout of a live-stream video advertisement clip according to an embodiment of the invention. In particular, FIG. 2 depicts a live-stream playlist 202—in this example an HLS live-stream playlist—comprising a list of segment identifiers, URLs, of live-stream segments that are stored on the network node 113. As described above, playlist 202 is a dynamic live-stream playlist file which is continuously updated so that it always identifies most recent segments that are available for playout. The updating process may include deleting the oldest segments identifiers and adding newly received segment identifiers to the playlist. The playlist 202 may include information for signaling the video player that the playlist is a dynamic playlist identifying segments belonging to a live-stream. For example, the absence of an end indicator in the playlist 202 (in HLS such end indicator may be an #EXT-X-ENDLIST element) may signal the client device 102 that it continuously needs to receive new playlists so that it can request and download newly generated live-stream segments for playout.

Hence, a playlist for playout 202 of a live-stream video advertisement clip may be formed by the video ad processor 112 by selecting one or more segment identifiers 208, e.g. URLs, from the dynamic live-stream playlist 202 and forming a static advertisement playlist 204 comprising selected live-stream advertisement segments. To that end, the video ad processor 112 may create a static playlist comprising an end indicator 210 for signaling the client device 102 that the playlist 202 only comprises a predetermined (i.e. limited) number of live-stream advertisement segments. For example, in an HLS embodiment, the video ad processor 112 may use an #EXT-X-ENDLIST element as an end indicator for signaling the video player that the segments form a video clip of a predetermined length.

As shown in FIG. 1, the network node 113 may send selected live-stream advertisement segments and the associated advertisement playlist to an HTTP server which may store the live-stream segments and associated advertisement playlist on one or more servers 110, e.g. one or more HTTP servers so that they can be retrieved by client devices.

The above-described process of selecting live-stream advertisement segments and forming an associated advertisement playlist on the basis of live-stream segments and a dynamic live-stream playlist may be repeated such that the HTTP server is able to send the most recent available live-stream advertisement segments and associated advertisement playlist to a client device 102.

In an embodiment, the video ad processor and the HTTP server may be implemented on separate network nodes. Alternately, the video ad processor and the HTTP server may be implemented on a single network node. During live-streaming, live-stream advertisement segments and associated playlist files may be continuously generated and stored on the one or more servers so that they can be accessed by video players, including video players that support VAST video ad clips.

For example, when a client device 102 is triggered by a video application to request the playout of an online video stream, the client device 102 may send a request 106, preferably a VAST request, to the ad-server 104, which—in response—may send a response 108, preferably a VAST response, comprising at least a URL of a network node that is configured to transmit an advertisement video clip or information for transmitting an advertisement video clip (e.g. a playlist) to the client device 102. The response may comprise an URL of an HTTP server 110 that comprises one or more stored live-stream advertisement segments 109 and associated advertisement playlist 111.

The client device 102 may use the URL in the ad server response 108 to send a request 122 to the HTTP server 110, which in response will send an advertisement playlist 124 to the video player. The client device 102 may use the playlist file for sequentially requesting and receiving live-stream advertisement segments 126 from the HTTP server 110. The media data in the live-stream advertisement segments may be played-out by the media player as a live-stream video advertisement.

As shown by FIGS. 1 and 2, transforming parts of a dynamic live-stream playlist into a static video-on-demand (VOD) playlist, live-stream segments may be used in live-stream video ads services which can be rendered using conventional client devices that support VAST. The system allows standard VAST compliant video players to render video ads comprising content of live-stream that is played-out at that moment. This way, a content provider or a broadcaster may use the live-stream video ad to inform viewers of a live-stream (e.g. sports or music) event that is broadcasted (or going to be broadcasted).

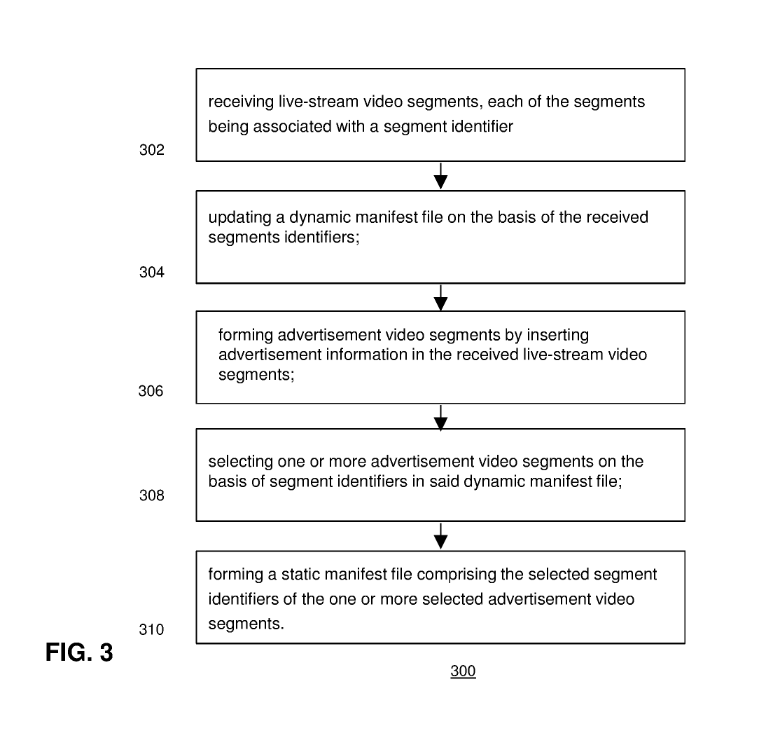

FIG. 3 depicts a method of generating a live-stream video advertisement according to an embodiment of the invention. The method may include receiving live-stream video segments (step 302), wherein each of the segments is identified by a segment identifier, preferably an URL. A live-stream playlist may be updated on the basis of the received live-stream segments (step 304). Then, advertisement segments may be formed by inserting advertisement information, e.g. a video and/or audio overlay in the received live-stream video segments (step 306). At least part of the thus formed advertisement segments may be selected on the basis of segment identifiers in said live-stream playlist file (step 308). Thereafter, a (static) video-on-demand playlist may be formed comprising the segment identifiers of the one or more selected advertisement video segments (step 310). The selected live-stream advertisement segments and associated advertisement playlist may be stored on a server that is configured to communicate with client devices that may use the playlist in order to playout the live-stream advertisement segments as a live-stream advertisement ad. This process may be executed by a video ad processor that is executed on a network node, e.g. a server, as described with reference to FIG. 1.

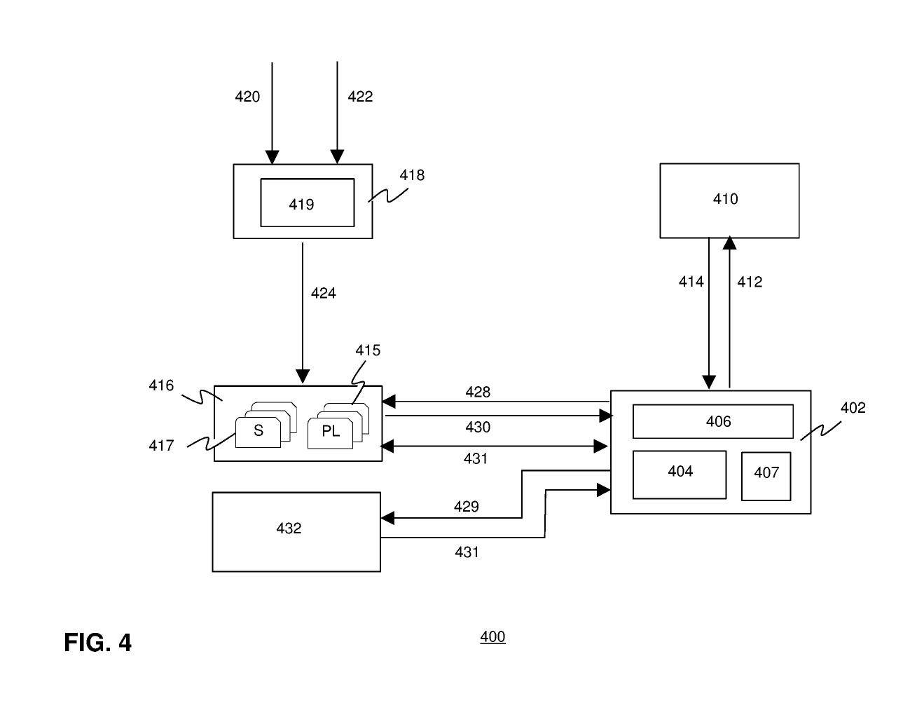

FIG. 4 schematically depicts a live-streaming video advertisement system according to another embodiment of the invention. In particular, FIG. 4 depicts a live-streaming video advertisement system wherein the advertisement information is added to the live-streaming segments at the client-side. The advertisement system may comprise a media processing device 402 comprising a client device 404 that is configured to communicate with network nodes 410,416,432, e.g. ad servers and/or HTTP servers, in a similar way as described with reference to FIG. 1. The system may comprise at least one network node 418, e.g. a server, comprising a video ad processor 419 configured to receive and buffer live-stream segments 420. The video ad processor 419 may be configured to form a live-stream playlist 422 and maintain the information in the live-stream playlist file 422 in sync with the received segments in a similar way as described with reference to FIG. 1. Hence, the live-stream playlist 422 is a dynamic playlist in the sense that it is continuously updated.

During the reception of the live-stream segments and the associated process of updating the live-stream playlist file 422, the video ad processor 419 may select one or more subsequent live-stream segments, e.g. a sequence of live-stream segments, and form a static VOD-type advertisement playlist comprising a number of segment identifiers of the selected live-stream segments.

Thereafter, the selected live-stream segments and the associated advertisement playlist file 422 may be forwarded 424 to an HTTP server 416. The process of forming a static advertisement playlist on the basis of a dynamic live-stream playlist and transmitting the static advertisements and the live-stream segments identified therein to the HTTP server may be repeated so that the HTTP server always has an up-to-date set of stored live-streaming segments S 417 and associated advertisement playlist PL 415 that can be requested by a client device 404 at any time during the live-stream session. In an embodiment, when receiving an advertisement playlist and associated segments, the HTTP server may replace, e.g. overwrite, the earlier advertisement playlist/live-stream segments with the newly received playlist/segments.

Hence, in the embodiment of FIG. 4, the video ad processor 419 does not add advertisement information to the live-streaming segments. Instead, advertisement information is transmitted separately to the client device 404. Thereafter, the advertisement information (e.g. video and/or audio overlay) and the media data in the live-stream segments may be played-out simultaneously. To that end, in an embodiment, an advertisement information server 432 may be configured to upload and store advertisement information 426 that can be requested by the client device 404.

The advertisement information may include static overlay graphics or dynamic overlay graphics (e.g. in the form of a video clip). Further, the advertisement information may include a sound “overlay”, e.g. a custom sound file, which will start playing as soon as the ad starts playing. In an embodiment, the sound overlay may include a custom commentary to the live-stream video ad clip. As the content of the video ad clip is live content, it is not possible to predict the content (both video and sound) of the ad at the moment it is shown to a user. Using the sound overlay, a custom audio file may be created that will always start at a pre-defined time, for example at the beginning.

When the client device 404 in the media processing device receives—in response to a request 412 for an advertisement video clip—an ad server response 414, it may use the information in the response to request live-stream segments and associated advertisement information from the network.

The ad server 410 may send an ad server response to the client device 404, wherein the ad server response may comprise a reference (e.g. an URL or a network address) to a media server 416, e.g. an HTTP media server. Additionally, the ad server response may comprise metadata for signaling the client device 404 that it needs to retrieve advertisement information which needs to be rendered simultaneously with the media data in the live-streaming segments. To that end, the client device 404 may comprise an advertisement information processor 406 that is configured to receive and process advertisement information (in the form of static and/or dynamic video data and/or audio data) so that it can be played-out at the same time as the media data in the live-stream segments that are played-out by a media player 407. Different ways for transmitting the advertisement information to the client device 404 are possible.

For example, in an embodiment, the client device 404 may use a first URL in the ad server response in order to request 428 an advertisement playlist from the HTTP server. The HTTP server may send the requested advertisement playlist in a response 430 to the client device 404 so that the client device 404 can use the playlist for sequentially requesting and receiving 431 live-stream segments for playout. Further, it may use a second URL in the ad server response in order to request 429 advertisement information, e.g. a static video overlay or dynamic video overlay (e.g. in the form of a VOD-type video clip), from an advertisement information server 432. After receiving the live-stream segments and the advertisement information, the client device 404 may control the media player 407 and the advertisement information processor 406 in order to simultaneously playout the media data in the live-stream segments (e.g. decode the media data into video frames) and advertisement information.

Instead of independently processing the media data and the advertisement information and displaying the thus processed media data and ad information in one display, the media data may be decoded in video frames and the advertisement information may be added to the video frames using e.g. a well-known fusion process before rendering the video frames on a display.

In a further embodiment, instead of providing the client device 404 a reference to an advertisement information server (e.g. in the form of a second URL), a reference to an advertisement information server 432 may be inserted in the playlist that is sent to the client device 404. For example, when the HTTP server 416 receives a static VOD-type advertisement playlist from the video ad processor 419, it may insert a reference, e.g. an URL, in the advertisement playlist to an advertisement information server 432. This way, the client device 404 may use the information in the playlist for both requesting live-stream segments and advertisement information.

Adding the advertisement information to the media data in the live-stream segments on the client-side instead of server-side may save encoding resources, as the original live-stream does not require continuous, real-time transcoding in the network. Furthermore, it enables the client device to control the enhancement of the media data of the live-streaming segments with advertisement information. For example, it enables the client device to determine the time of the start of the overlay video. In another embodiment, it allows the execution of an interactive overlay, e.g. an HTML5 or CSS overlay button, that may be used to redirect the user to a website where the advertised live-stream can be accessed.

In an embodiment, the advertisement server 410 may be a VAST-compliant advertisement server, wherein—in response to a VAST request 412 from the client device 404 —, the advertisement server 410 may send a VAST response 414 to the client device 404. The VAST response may include an XML file defining one or more URLs associated with at least one HTTP server that is configured to provide a static VOD-type advertisement playlist to the client device 404.

Further, the VAST response 414 may further comprise an advertisement information indicator for signaling the advertisement information processor 406 that the advertisement information in the form of visual or audio overlay needs to be played-out simultaneously with the media data of the live-stream segments. Further, the VAST response may comprise metadata that the advertisement information processor 406 requires for processing and playout of the advertisement information. The metadata may e.g. include information on the data format, video/audio codec, resolution of the visual or audio overlay, etc. In a further embodiment, the VAST response may comprise an overlay identifier, e.g. an URL, which the client device 404 may use for requesting a visual and/or audio overlay from an advertisement information server.

Hence, by implementing the processing of the advertisement information as an extension to the VAST standard, both conventional VAST-compatible, video-on-demand type advertisement video clips and live-stream video ads comprising enhanced features, including but not limited to visual overlays, sound overlays, HTML overlays, picture-in-picture video overlays, and consume premium content directly from the ad (e.g. using an interactive play button), may be realized.

Although the system in FIG. 4 is described with reference to several network elements 418,416,432,410, it is clear for the skilled person that some or all functions associated with the network elements, e.g. servers, can be implemented in one network entity, e.g. a central server or a server system, without departing from the invention.

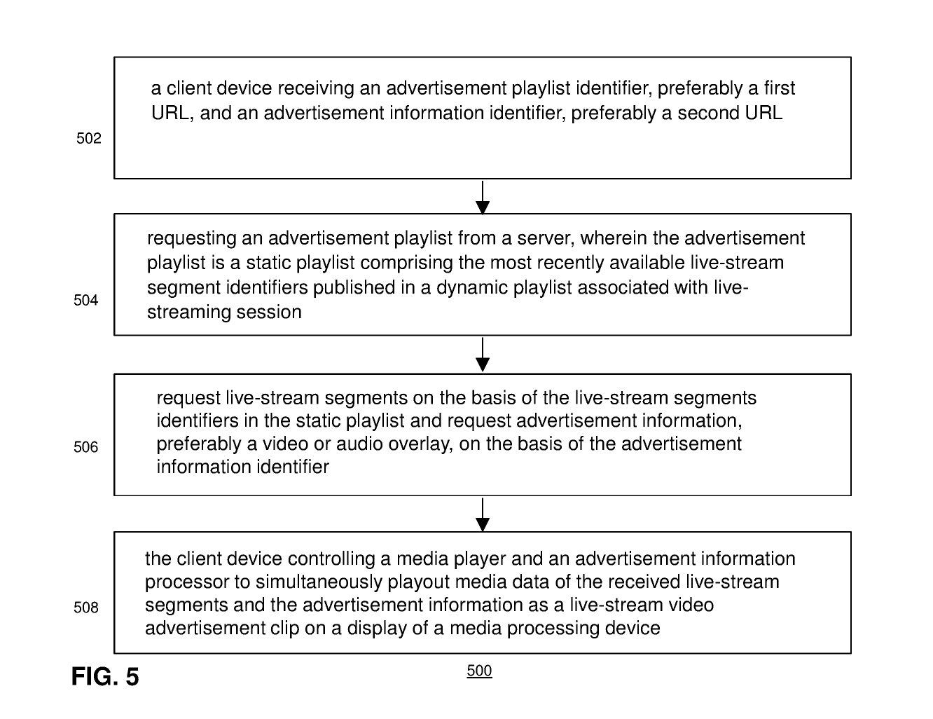

FIG. 5 depicts a method of rendering a live-stream video advertisement according to an embodiment of the invention. The method may include a client device 404 receiving an advertisement playlist identifier, preferably a first URL, and an advertisement information identifier, preferably a second URL (step 502). Thereafter, the advertisement playlist identifier may be used to request an advertisement playlist from a server, wherein the advertisement playlist is a static (video-on-demand type) playlist comprising the most recently available live-stream segment identifiers published in a dynamic live-stream playlist (step 504). The client device 404 may request live-stream segments on the basis of the live-stream segments identifiers in the static VOD playlist and request advertisement information, e.g. a visual or audio overlay, on the basis of the advertisement information identifier (step 506). The client device 404 controls a media player and an advertisement information processor to simultaneously playout media data of the received live-stream segments and the advertisement information as a live-stream video advertisement clip on a display of a media processing device (step 508).

In the embodiments described with reference to FIG. 1-5 above, advertisement playlists are created in the form of static playlists, e.g. video-on-demand type playlists, comprising the most recently available live-stream segment identifiers published in a dynamic live-stream playlist. In further embodiments, the information in the dynamic playlist may be used in order to create advertisement playlists wherein all or at least part of the live-stream segment identifiers are not yet available for request by a client device, but are going to be available in the near future, e.g. within a predetermined period from the creation of the static playlist comprising the live-stream segment identifiers.

For example, as shown in FIG. 2, a dynamic live-stream playlist comprises segment identifiers of a certain format including a segment counter and/or a time information associated with e.g. the creation of the live-stream segment file. For example, the most recently available segment in the playlist 202 is identified by the URI segment_53776_20151102110026.ts, wherein the URI comprises a segment number 53776 and a segment timestamp 20151102110026. Each time new segments are added to the dynamic playlist, the segment number and/or the segment time stamp will increase in a predictable way. Hence, on the basis of the information in the dynamic playlist segment identifiers of live-stream segments may be derived that are going to be available in the (near) future.

This way, in an embodiment, a period in the future, i.e. ahead of the current time, may be selected as the period wherein a number of predetermined live-stream segments of a live-stream session are going to be made available by the network. Based on e.g. the duration of the segments, the segment numbers and/or segment time stamps associated with the selected period may be determined. These segment numbers may then be used to determine one or more live-stream segment identifiers for the selected period.

In an embodiment, an availability indicator may be inserted in the static playlist for signaling a client device that the live-segments defined in the static playlist are going to be available in the near future. Hence, in that case the client may wait for the availability of the live-stream segments before it starts requesting them. To that end, the availability indicator may be associated with availability information, e.g. a clock time or the like, for signaling a client device at what time it should start requesting and playout live-stream segments that are listed in the static playlist it received. Alternatively, the client device may use the information in the static playlist, e.g. the segment time stamp, at what time it should start requesting the live-stream segments identified in the static playlist.

Alternatively, in another embodiment, the client device may request segments that are listed in the static playlist from the server, and in case a segment is not yet available for transmission, the server will make the client wait until the segments are available. This way, a client device do not need additional functionality in order to process playlist that comprise live-stream segment identifiers of live-stream segments that will be made available by a server in the (near) future.

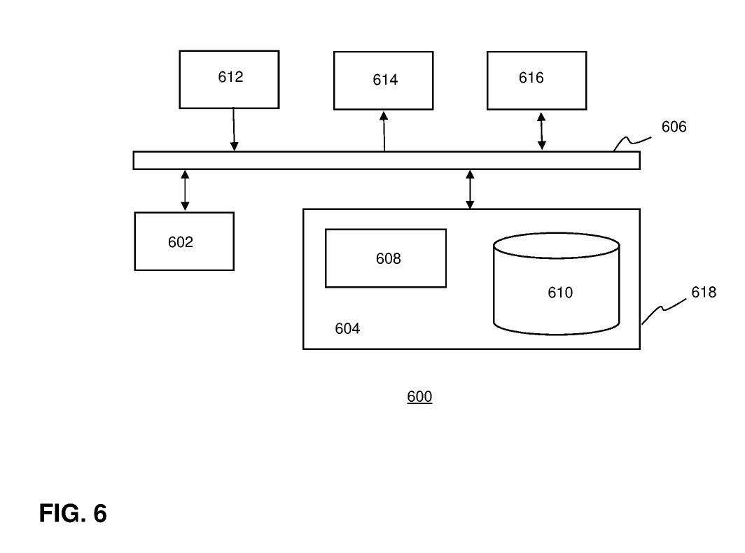

FIG. 6 is a block diagram illustrating an exemplary data processing system that may be used in as described in this disclosure. Data processing system 600 may include at least one processor 602 coupled to memory elements 604 through a system bus 606. As such, the data processing system may store program code within memory elements 604. Further, processor 602 may execute the program code accessed from memory elements 604 via a system bus 606. In one aspect, a data processing system may be implemented as a computer that is suitable for storing and/or executing program code. It should be appreciated, however, that data processing system 700 may be implemented in the form of any system including a processor and memory that is capable of performing the functions described within this specification.

Memory elements 604 may include one or more physical memory devices such as, for example, local memory 608 and one or more bulk storage devices 610. Local memory may refer to random access memory or other non-persistent memory device(s) generally used during actual execution of the program code. A bulk storage device may be implemented as a hard drive or other persistent data storage device. The processing system 600 may also include one or more cache memories (not shown) that provide temporary storage of at least some program code in order to reduce the number of times program code must be retrieved from bulk storage device 610 during execution.

Input/output (I/O) devices depicted as input device 612 and output device 614 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Input device and/or output device may be coupled to data processing system either directly or through intervening I/O controllers. A network adapter 616 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 650.

As pictured in FIG. 6, memory elements 604 may store an application 618. It should be appreciated that data processing system 600 may further execute an operating system (not shown) that can facilitate execution of the application. Application, being implemented in the form of executable program code, can be executed by data processing system 700, e.g., by processor 602. Responsive to executing application, data processing system may be configured to perform one or more operations to be described herein in further detail.

In one aspect, for example, data processing system 600 may represent a client data processing system. In that case, application 618 may represent a client application that, when executed, configures data processing system 600 to perform the various functions described herein with reference to a “client”. Examples of a client can include, but are not limited to, a personal computer, a portable computer, a mobile phone, or the like.

In another aspect, data processing system may represent a server. For example, data processing system may represent an (HTTP) server in which case application 618, when executed, may configure data processing system to perform (HTTP) server operations. In another aspect, data processing system may represent a module, unit or function as referred to in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the aspects of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles and/or aspects of the invention and the practical application, and to enable others of ordinary skill in the art to understand aspects of the invention for various embodiments with various modifications as are suited to the particular use contemplated. In other words, although the subject matter has been described in language specific to structural features and/or methodological acts, it is to be understood that the subject matter defined in the appended claims is not necessarily limited to the specific features or acts described above as has been held by the courts. Rather, the specific features and acts described above are disclosed as example forms of implementing the claims.

1. A method of forming a live-stream advertisement video clip comprising:
receiving live-stream video segments associated with a live-streaming session, wherein each of the live-stream segments is identified by a live-stream segment identifier;
updating a dynamic playlist with a processor on the basis of the live-stream segments identifiers of the received live-stream segments;
forming a static playlist on the basis of live-stream identifiers in said updated dynamic playlist, the static playlist comprising the most recently available live-stream segment identifiers of the updated dynamic playlist and/or live-stream segment identifiers that are going to be available in the future; and,
associating video and/or audio advertisement information with the live-stream segment identifiers.

2. The method according to claim 1 wherein associating visual and/or audio advertisement information with the live-stream segment identifiers comprises:
adding an advertisement information identifier associated with the video and/or audio advertisement information in the static playlist.

3. The method according to claim 1 wherein associating visual and/or audio advertisement information with the live-stream segment identifiers comprises:
adding video and/or audio advertisement information to the received live-stream video segments.

4. The method according to claim 1 further comprising:
storing the static playlist, the live-stream segments identified in the playlist and the video and/or audio advertisement information on a server system.

5. The method according to claim 1 wherein the live-stream segments, the dynamic playlist and the static playlist are formatted according to an HTTP streaming protocol.

6. A method of rendering live-stream advertisement video clip comprising:
a client device receiving a static playlist comprising one or more live-stream segment identifiers, the static playlist comprising the most recently available live-stream segment identifiers published in a dynamic playlist and/or live-stream segment identifiers that are going to be available in the future;
requesting live-stream segments on the basis of the live-stream segments identifiers in the static playlist and requesting video and/or audio advertisement information associated with the live-stream segment identifiers; and,
the client device controlling a media player and an advertisement information processor to simultaneously playout media data of the received live-stream segments and the advertisement information as a live-stream video advertisement clip on a display of a media processing device.

7. The method according to claim 6 further comprising:
requesting a server for information for rendering a live-stream advertisement video clip;
receiving a response from the server, the response comprising one or more references for locating one or more servers configured to provide the static playlist and/or the advertisement information to the client device.

8. The method according to claim 7 wherein the response further comprises information for signaling the client device that visual advertisement information can be retrieved on the basis of the one or more references and/or for initializing the advertisement information processor for playout of advertisement information identified in the response.

9. The method according to claim 6 wherein the advertisement information processor uses the advertisement information for rendering an interactive region on a user interface during the playout of the media data in the live-stream segments the client device being redirected the client to a server for joining the live-stream session.

10. A server comprising:
a computer readable storage medium having computer readable program code embodied therewith, and
a processor coupled to the computer readable storage medium, wherein responsive to executing the first computer readable program code, the processor is configured to perform executable operations comprising:
receiving live-stream video segments associated with a live-streaming session, wherein each of the live-stream segments is identified by a live-stream segment identifier;
updating a dynamic playlist stored on the basis of the live-stream segments identifiers of the received live-stream segments;
forming a static playlist on the basis of live-stream identifiers in said updated dynamic playlist, the static playlist comprising the most recently available live-stream segment identifiers of the updated dynamic playlist and/or live-stream segment identifiers that are going to be available in the future; and,
associating video and/or audio advertisement information with the live-stream segment identifiers.

11. The server according to claim 10 wherein the executable operations further comprise:
adding an advertisement information identifier associated with the video and/or audio advertisement information in the static playlist; or,
adding video and/or audio advertisement information to the received live-stream video segments; or,
storing the static playlist, the live-stream segments identified in the playlist and the video and/or audio advertisement information.

12. A client device comprising:
a computer readable storage medium having at least part of a program embodied therewith, the computer readable storage medium comprising a playlist file; and,
a computer readable storage medium having computer readable program code embodied therewith, and
a processor coupled to the computer readable storage medium, wherein responsive to executing the computer readable program code, the processor is configured to perform executable operations comprising:
a client device receiving a static playlist comprising one or more live-stream segment identifiers, the static playlist comprising the most recently available live-stream segment identifiers published in a dynamic playlist and/or live-stream segment identifiers that are going to be available in the future;
requesting live-stream segments on the basis of the live-stream segments identifiers in the static playlist and requesting video and/or audio advertisement information associated with the live-stream segment identifiers; and,
the client device controlling a media player and an advertisement information processor to simultaneously playout media data of the received live-stream segments and the advertisement information as a live-stream video advertisement clip on a display of a media processing device.

13. The client device according to claim 12 wherein the executable operations further comprise:
requesting a server for information for rendering a live-stream advertisement video clip;
receiving a response from the server, the response comprising one or more references for locating one or more servers configured to provide the static playlist and/or the advertisement information to the client device.

14. The client device according to claim 13 wherein the executable operations further comprise:
initializing the advertisement information processor for playout of advertisement information identified in the response.

15. The client device according to claim 13 wherein the executable operations further comprise:
rendering an interactive region on a user interface during the playout of the media data in the live-stream segments the client device being triggered to join the live-stream session.

16. The computer program product comprising software code portions configured for, when run in the memory of a computer, executing the method steps according to claim 1.
